(19) United States
(12) Patent Application Publication
(10) Pub. No.: US 2004/0122614 A1
(43) Pub. Date: Jun. 24, 2004

(54) Noise controller for controlling noise and method of removing noise

(75) Inventors: Sang Chui Youn, Gyeonggi (KR); Seung Ko Lee, Seoul (KR)

Correspondence Address: BIRCH STEWART KOLASCH & BIRCH, PO BOX 747, FALLS CHURCH, VA, 22040-0747, US

(73) Assignee: LG ELECTRONICS, INC.

(21) Appl. No.: 10/732,300

(22) Filed: Dec. 11, 2003

Related U.S. Application Data
(63) Continuation of application No. 09/716,222, filed on Nov. 21, 2000.
Application No. 09/716,222 is a continuation-in-part of application No. 08/970,455, filed on Nov. 14, 1997, now abandoned.

(30) Foreign Application Priority Data
Nov. 14, 1996 (KR) 1996-53992
Dec. 28, 1996 (KR) 1996-75061
Dec. 28, 1996 (KR) 1996-75062

(51) Int. Cl. G01D 1/00

(52) U.S. Cl. 702/127

(57) ABSTRACT

An apparatus and method to actively control noise is disclosed. The input noise is cancelled by generating a control noise that is opposite in phase and same in amplitude as the original noise. The input noise and the control noise is mixed to generate a residual noise signal and an error variation signal. Using the residual noise and the error variation signals as feed back, the control noise is generated such that the residual noise is minimized. The noise controlling apparatus includes phase perceiving part to perceive the phase of the input noise and a micro computer part that processes and generates the control noise without delay in phase from the input noise.

### CONTINUATION INFORMATION

This application is a Continuation Application of application Ser. No. 09/716,222 filed on Nov. 21, 2000, which is further a Continuation-in-Part of application Ser. No. 08/970,455 filed on Nov. 14, 1997, the entirety of both of which are hereby incorporated by reference.

### FIELD OF THE INVENTION

This invention relates to a noise controller and a method of removing noise. More particularly, this invention relates to a noise controller for actively controlling noise, such as motor or actuator noise from a household electric appliance, and a method of actively removing the noise.

### BACKGROUND OF THE INVENTION

When a progressing wave having a constant amplitude and phase encounters a wave having the opposite amplitude and phase, the progressing wave is canceled based on a concept known as destructive interference.

FIG. 1 is a drawing showing the principle of actively controlling noise, wherein generated noise is canceled by an artificial sound using the principle of destructive interference. Applying this principle, as illustrated by FIG. 2, it is possible to cancel a noise signal N by duplicating (N+S) an artificial signal S having the same amplitude and opposite phase.

FIG. 3 is a block diagram showing the principle of actively controlling the noise according to the prior art. The conventional noise controller comprises a sensor part 1 for perceiving the noise signal, a signal amplifying part 2 for amplifying the perceived noise signal, a first low-pass filtering part 3 for low pass filtering the amplified noise signal, a digital signal processor (DSP) 4 for processing the amplified low pass filtered noise signal without phase delay, a microcomputer part 5 for also processing the amplified low pass filtered noise signal from the first low-pass filtering part 3 in parallel with the DSP 4, a second low-pass filtering part 6 for low pass filtering the control noise signal from the DSP 4, an electric power amplifying part 7 for electric power amplifying the control noise signal, and an output part 8 for outputting the electric power amplified noise control signal.

The operation of the above-identified prior art is described in detail hereinafter by FIG. 3 to FIG. 5.

The sensor part 1 perceives the noise signal X(k) using a micro phone (not illustrated). The signal amplifying part 2 amplifies the noise signal X(k) perceived by the sensor part 1 and outputs the amplified signal to the first low-pass filtering part 3. The low-pass filtered noise signal X(k) from the low-pass filtering part 3 is changed into a digital signal by an analog-to-digital (A/D) converter (not illustrated) in the DSP 4. A control signal, which has same amplitude but opposite phase to the noise signal, is output through a digital to analog (D/A) converter (not illustrated). The DSP 4 initializes the system and determines a degree of the filter.

The low-pass filtered noise signal X(k) from the first low-pass filtering part 3 is changed into a digital signal by an analog-to-digital (A/D) converter (not depicted) of DSP 4, then, as shown in detail by FIG. 4, the digital version of noise signal X(k) is output through a control target system 4a in the DSP 4. At the same time, a digital filtering coefficient controlling part (DFCCP) 4b computes a digital filtering coefficient based on the analog low-pass filtered noise signal X(k) received from the first low-pass filtering part 3, and outputs a modified digital filtering coefficient signal Y(k). Y(k) is a digital version of the output signal generated from the output part 8.

A mixer 4c in the DSP 4 outputs a residual noise signal E(k) by mixing an artificial sound output from the system 4a with the digital filtering coefficient signal Y(k) modified from the DFCCP 4b.

The DFCCP 4b in the DSP 4 adjusts the digital filtering coefficient signal Y(k) based on feedback of the residual noise signal E(k) to a level where the residual noise signal E(k) is minimized. The signal is converted by a digital-to-analog (D/A) converter (not depicted) and outputted as the control signal to the second low-pass filtering part 6.

The second low-pass filtering part 6 low-pass filters the control signal by DSP 4 and outputs the result. The electric power amplifying part 7 amplifies the signal from the second low pass filtering part 6 and outputs the electric power amplified signal to the output part 8, which actually generates the canceling noise.

The above-identified apparatus requires a DSP chip, which is expensive. Because the conventional system and method of perceiving and controlling noise requires the DSP chip to be applied to each household electric appliance, such as a refrigerator and a washing machine, it is prohibitively expensive.

### SUMMARY OF THE INVENTION

It is an object of the present invention to provide a noise controller for actively controlling noise, for instance, from a motor or actuator noise generated by a household electric appliance. Such motor or actuator generates a noise that is predominantly regular, i.e., the noise has predictable frequencies. For example, the frequencies are likely to be some multiple of 60 Hz, which is the frequency of household electric power.

It is another object of the present invention to actively remove the noise by using the noise controller.

In order to achieve the above-mentioned objects, a noise controller in accordance with the present invention comprises a sensor part perceiving a noise and outputting a noise signal corresponding to said noise, a phase perceiving part perceiving a phase of said noise signal and outputting a phase signal; and a micro computer part generating a noise control signal based a residual noise signal and an error variation signal.

Further, to achieve the above-mentioned objects, a method to actively control noise comprises perceiving a noise and generating a noise signal, perceiving a phase of said noise signal and generating a phase signal; and generating a noise control signal based a residual noise signal and an error variation signal.

### BRIEF DESCRIPTION OF THE DRAWINGS

FIG. 1 is a drawing showing a prior art principle of an actively controlling a noise.

FIG. 2 is a drawing illustrating how noise is canceled in the prior art by duplicating characteristics of a noise signal N using an artificial signal S.

FIG. 3 is a block diagram showing a prior art system employing the principle of actively controlling noise.

FIG. 4 is a block diagram showing how the noise is actively controlled in a DSP of the prior art system of FIG. 3.

FIG. 5 is a flow-chart describing the process used to actively control noise in the DSP of the prior art system of FIG. 3.

FIG. 6 is a block diagram showing a system employing the principle of actively controlling noise according to the present invention.

FIG. 7 is a block diagram showing how noise is actively controlled in a microcomputer of the system of FIG. 6.

FIG. 8 is a flow-chart describing the process used to actively control noise in the microcomputer of the system of FIG. 6.

FIG. 9 is a drawing showing a control rule and generating an index data table. And

FIG. 10 is a diagram showing details of the phase perceiving part.

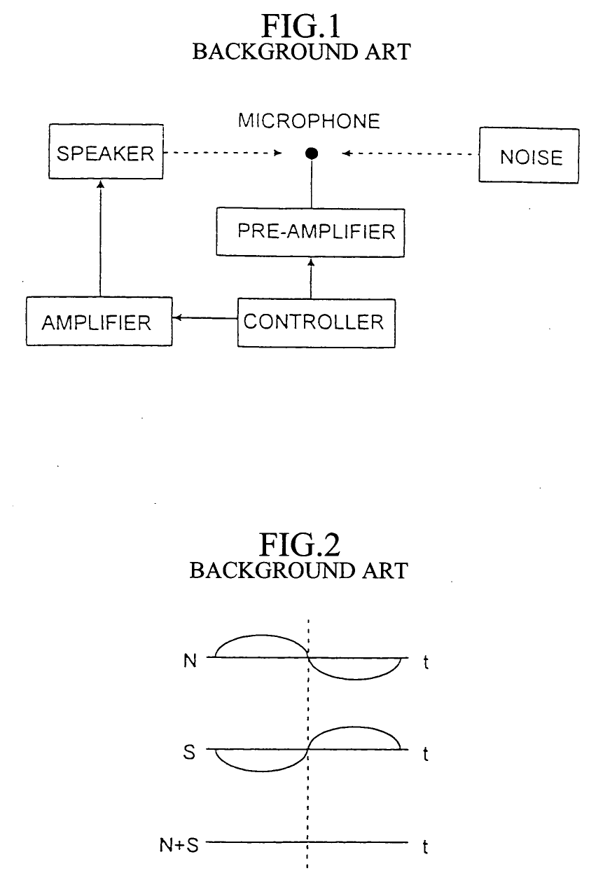

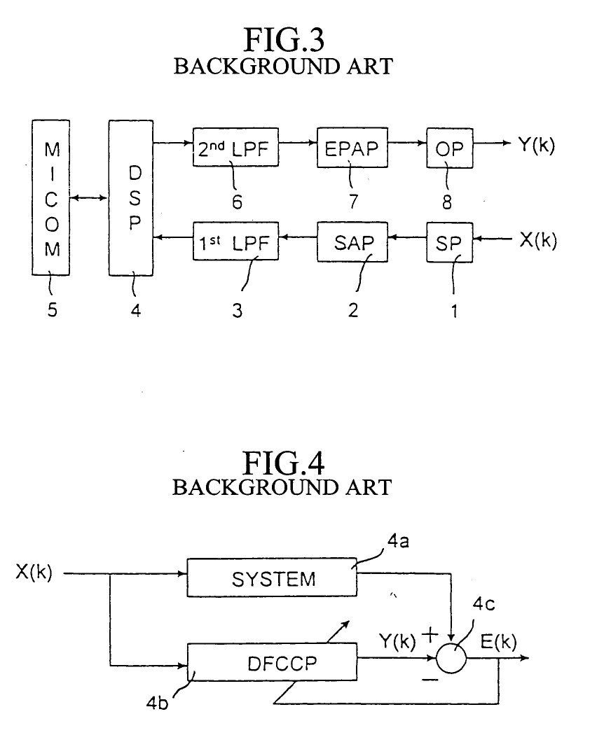

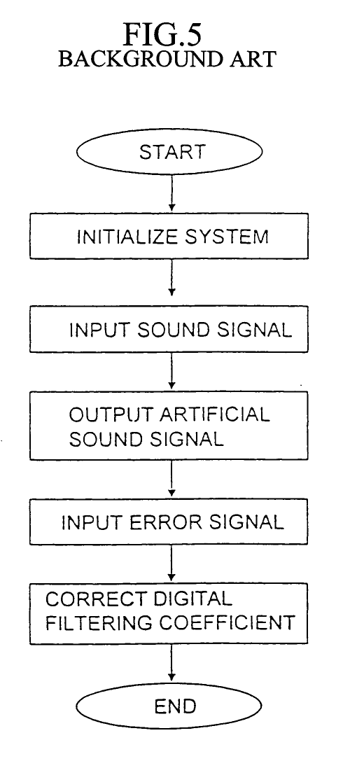

### DETAILED DESCRIPTION OF THE INVENTION

Some of the preferred embodiments of the present invention are described in detail hereinafter based on the accompanying drawings.

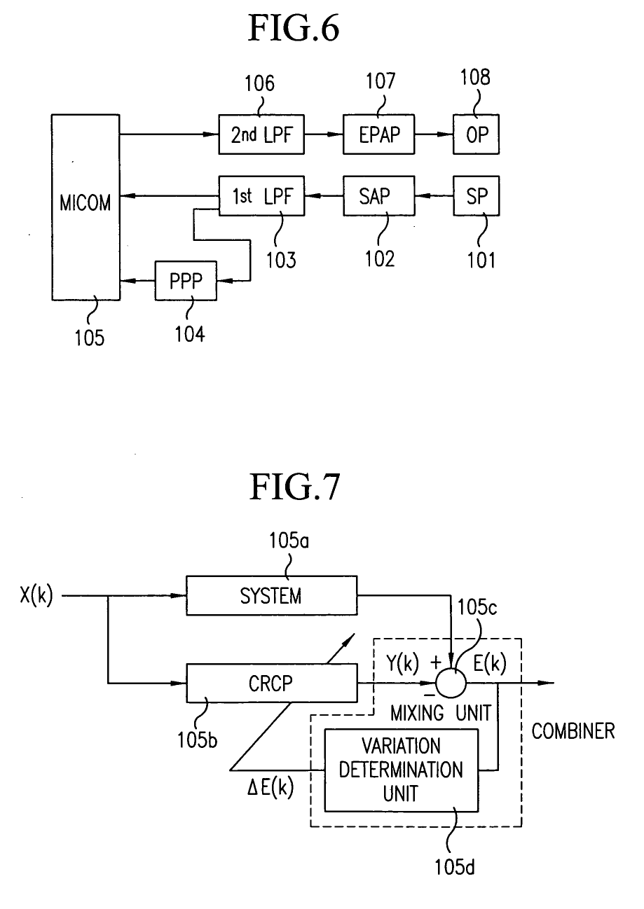

Referring to FIG. 6, the noise controller in accordance with the present invention comprises a sensor part 101 for perceiving a noise signal, a signal amplifying part 102 for amplifying the noise signal from the sensor part 101, a first low-pass filtering part 103 for low-pass filtering the noise signal from the signal amplifying part 102, a phase perceiving part 104 for perceiving a phase of the low-pass filtered noise signal from the first low-pass filtering part 103, a micro computer part 105 for processing the amplitude of the noise signal from the first low-pass filtering part 103 and the phase of that signal perceived by the phase perceiving part (PPP) 104 without delay in phase, a second low-pass filtering part 106 for low-pass filtering the noise signal from the micro computer part 105, and electric power amplifying part 107 for electric power amplifying the noise signal from the second low-pass filtering part 106, and an output part 108 for outputting the electric power amplified signal from the electric power amplifying part 107 to the sound acoustical sound field.

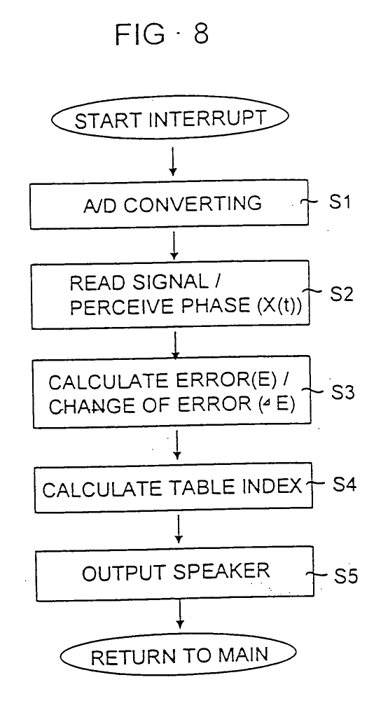

The operation of the noise controller having the above-identified structure is described hereinafter by accompanying FIG. 7 to FIG. 9.

The sensor part 101 perceives the noise signal X(k) in the sound acoustical sound field using a microphone (not illustrated) or the like. The noise signal may also be perceived through other ways, such as directly sensing the noise generator through mechanical, electrical, or acoustical methods. The signal amplifying part 102 amplifies the noise signal X(k) perceived by the sensor part 101 and outputs the amplified noise signal to the first low-pass filtering part 103. The noise signal X(k) contains both phase and amplitude information. The amplitude information of the noise signal X(k) output from the first low-pass filtering part 103 is directly input to the microcomputer part 105. On the other hand, the phase information of the noise signal X(k) output from the first low-pass filtering part 103 is output to the microcomputer part 105 via the phase perceiving part 104. The microcomputer is interrupted and changes the amplified low-pass filtered noise signal X(k) received through the first low-pass filtering part 103 into a digital signal using an analog-to-digital (A/D) converter (not illustrated) (Step S1). At the same time, the phase perceiving part 104 detects and outputs the phase of the amplified low-pass filtered noise signal X(k) received through the first low-pass filtering part 103 (Step S2).

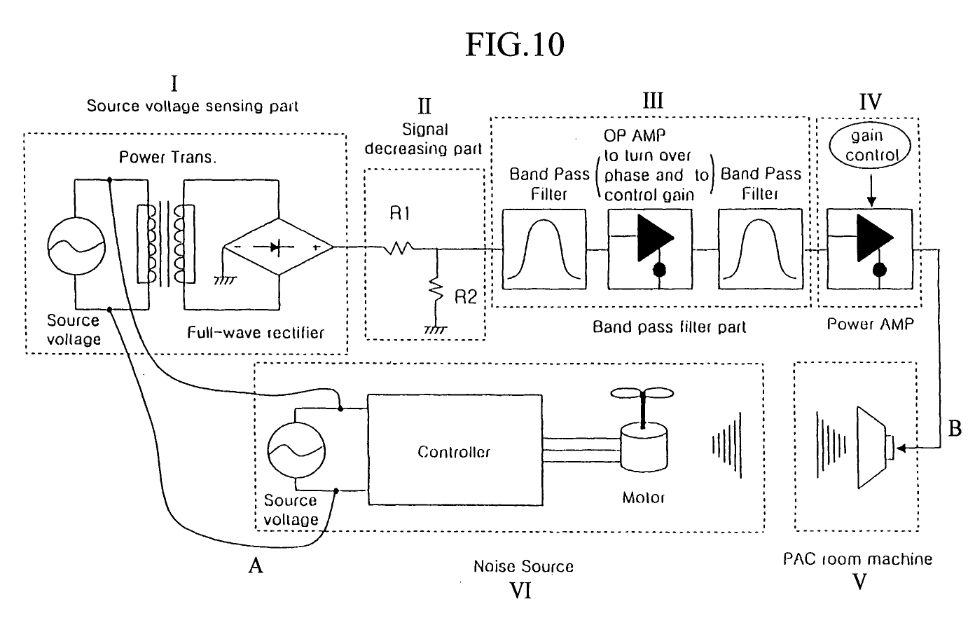

In FIG. 10, the phase perceiving part 104 includes a voltage sensing part I, a signal decreasing part II, a bandpass filter part III, a power amp part IV, a PAC room machine (speaker) V, and a Noise source VI. Each of the parts II, III, and IV are in the CRCP 105b.

The noise signal A which is synchronized with the frequency of the voltage sensing part I is output through the Noise source VI. The signal A is expressed by A=sin(ωₒ+α)t.

The signal A with a rating voltage (220V or 110V) is decreased by the resistance of resistors R1 and R2 of the signal decreasing part II and is inputted into the bandpass filter part III.

In the bandpass filter part III, the inputted signal passes through a first bandpass filter, an op amp and a second bandpass filter, and a reverse signal having the opposite phase from the inputted signal is output.

This reversed signal is amplified by the power amp part IV and output through the speaker V as a signal B. (B=sin ωzₒt, B being the reverse signal of A.)

The signal A is offset by the signal B. The noise signal A corresponds to said signal X(k) and the reverse signal B corresponds to said signal Y(k).

Therefore, the signals A and B are mixed to be the residual noise signal E(k). CRCP 105b outputs the reverse signal B of E(k) inputted therein. Such process goes on to decrease the value of E(k), so that the value of E(k) approaches zero.

In FIG. 10, B represents the noise and A represents the canceling noise. Mathematically, the relationship is as follows:

If B=sin ωₒt then A=sin(ωₒ+α)t such that A+B=sin(ωₒ+α)t+sin ωₒt≈0

where −180°≦α≦180°.

The noise is cancelled based on the phase shift according to the variation of α.

The microcomputer part 105 outputs a digital version of the the noise signal X(k) through a control target system 105a, as shown in FIG. 7. The microcomputer part 105 also generates a modified signal Y(k), which is converted to an analog signal by a digital-to-analog converter (not illustrated).

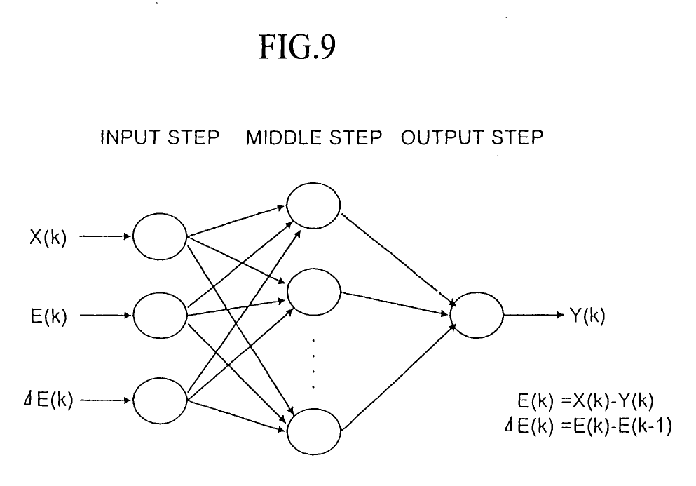

In a control rule controlling part (CRCP) 105b of the microcomputer part 105, an input value and output value are compared to each other. More specifically, in CRCP 105b, a residual noise signal E(k) output from a mixer 105c of the microcomputer 105 and a modeling value of the noise signal X(k) are compared to each other one-to-one using a neural network, as shown in FIG. 9.

In FIG. 7, CRCP 105b outputs the reverse signal Y(k) of the inputted signal X(k). The signal Y(k) and the signal X(k) passed through system 105a are mixed in mixer 105c. The residual noise signal E(k) (E(k)=X(k)−Y(k)) output from mixer 105c is inputted to CRCP 105b. CRCP 105b outputs the reverse signal Y(k) of E(k) inputted therein. Y(k) is a function of X(k) and E(k)). This process goes on to decrease the value of E(k). The amplitude of the inputted signal is determined by the equation ΔE(k)=E(k)−E(k−1).

Mixer 105c of microcomputer part 105 calculates and outputs the residual noise signal E(k) by mixing the noise signal X(k) output from the system 105a with the signal Y(k) output from the CRCP 105b (Step S3) according to the following equation:

E(k)=X(k)−Y(k), ΔE(k)=E(k)−E(k−1),

where ΔE(k) is an error variation signal of the residual noise signal E(k).

A variation determination unit 105d senses the residual noise signal E(k) output from the mixing unit 105c and outputs the error variation signal ΔE(k). The mixing unit 105c and the variation determination unit 105d constitute a combiner. The error variation signal ΔE(k) is input to the CRCP 105b.

Using an index table of the memory (not illustrated) within the microcomputer memory, the microcomputer part 105 determines a phase that is opposite the phase of the phase signal corresponding to the noise signal X(k), and uses that phase to develop the phase of an artificial sound signal to be output through a digital-to-analog (D/A) converter (not illustrated) to second low-pass filter 106 (Step S4).

Thereafter, the CRCP 105b microcomputer 105 changes the artificial sound signal Y(k) to reduce the error of the residual noise signal E(k) to zero. The artificial sound signal Y(k) is changed based on feedback of the error of the residual noise signal E(k) output from the mixer 105c based on the equations discussed above.

The second low-pass filtering part 106 then filters the analog signal output from the microcomputer part 105. Further, the electric power amplifying part 107 amplified the analog signal output from the second low-pass filtering part 106 and outputs the electric power amplified signal to the acoustical sound field (not shown) through the output part 108 (Step S5).

The above process is continually executed to remove the error signal of the residual noise signal E(k).

In accordance with the present invention, it is possible to actively control the noise being generated in motors or actuators of household electric appliances such as a refrigerator or washing machine.

While the described embodiment represents the preferred form of the present invention, it is to be understood that modifications will occur to those skilled in the art without departing from the spirit of the invention. The scope of the invention is therefore to be determined solely by the appended claim.

What is claimed is:

1. A noise controller for actively controlling noise, the controller comprising:
a sensor part perceiving a noise and outputting a noise signal corresponding to said noise;
a phase perceiving part perceiving a phase of said noise signal and outputting a phase signal, said phase perceiving part including a transformer transforming said noise signal, a full-wave rectifier rectifying a transformed noise signal from said transformer, a pressure-sensitive circuit converting a fully rectified signal from said full-wave rectifier, and a bandpass filter bandpass filtering a converted signal from said pressure-sensitive circuit; and
a micro computer part generating a noise control signal based on a residual noise signal and an error variation signal.

2. The noise controller of claim 1, further comprising:
a signal amplifying part amplifying said noise signal from said sensor part;
a first low pass filter filtering said amplified noise signal from said signal amplifying part and outputting a filtered noise signal to said phase perceiving part and said micro computer part;
a second low pass filter filtering said noise control signal from said micro computer part;
an electric power amplifying part amplifying a filtered noise control signal from said second low pass filter; and
an output part outputting an amplified filtered noise control signal from said electric power amplifying part.

3. The noise controller of claim 1, wherein said micro computer includes an index table.

4. The noise controller of claim 1, wherein said micro computer includes a neural net.

5. The noise controller of claim 1, wherein said micro computer includes a control rule controlling part (CRCP) generating said noise control signal to minimize said residual noise signal.

6. A method of actively controlling noise, the method comprising:
perceiving a noise and generating a noise signal;
perceiving a phase of said noise signal and generating a phase signal, said phase perceiving step comprising transforming said noise signal, full-wave rectifying said transformed noise signal, converting said fully rectified signal, and bandpass filtering said converted signal; and
generating a noise control signal based on a residual noise signal and an error variation signal.

7. The method of claim 6, further comprising:
amplifying said noise signal;
low pass filtering said amplified noise signal;
low pass filtering said noise control signal;
power amplifying said filtered noise control signal; and
outputting said power amplified filtered noise control signal.

8. The method of claim 6, wherein said residual noise signal and said error variation signal are generated through the use of a neural net.

9. The method of claim 6, wherein said noise control signal is generated to minimize said residual noise signal.
